(19) United States
(12) Patent Application Publication
(10) Pub. No.: US 2018/0357204 A1
(43) Pub. Date: Dec. 13, 2018

(54) GAUSSIAN RANDOM VARIABLE GENERATION

(71) Applicant: FUJITSU LIMITED, Kawasaki-shi (JP)

(72) Inventor: Pun Wai TONG, Campbell, CA (US)

(73) Assignee: FUJITSU LIMITED, Kawasaki-shi (JP)

(21) Appl. No.: 15/616,852

(22) Filed: Jun. 7, 2017

(51) Int. Cl. G06F 17/18

(52) U.S. Cl. CPC G06F 17/18

(57) ABSTRACT

A method may include obtaining a random variable set. The method may include obtaining a first parameter and a second parameter. The method may include obtaining a number of random variables to be used to generate a quasi-standard Gaussian random variable. The method may include determining, for each of the random variables to be used, a probability value that a corresponding random variable is equal to a first number based on the first parameter and the second parameter. The method may include determining, for each of the random variables to be used, a random variable coefficient value based on the probability value determined for the corresponding one of the random variables. The method may include generating the quasi-standard Gaussian random variable based on each random variable coefficient value determined for each of the random variables to be used and based on a value for each random variable to be used.

### FIELD

The embodiments discussed in the present disclosure are related to methods and systems for generating a Gaussian random variable.

### BACKGROUND

A Gaussian random variable typically may be generated for statistical analysis. For example, a Gaussian random variable may be generated for use in a Monte Carlo method of statistical analysis. In another example, a Gaussian random variable may be used to assist with statistical eye simulation of signal integrity analysis for high speed interconnects. Additionally, a Gaussian random variable may be used for statistical static timing analysis in a computer aided design (CAD).

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

According to an aspect of an embodiment, a method may include obtaining a random variable set {Yⱼ}ⱼ₌₁ⁿ of random variables Yⱼ. The method may include obtaining a first parameter para1. The method may include obtaining a second parameter para2. The method may include obtaining a number n of random variables Yⱼ to be used to generate a quasi-standard Gaussian random variable S(n). The method may include determining, for each of the random variables Yⱼ to be used, a probability value pⱼ that a corresponding one of the random variables Yⱼ is equal to a first number based on the first parameter para1 and the second parameter para2. The method may include determining, for each of the random variables Yⱼ to be used, a random variable coefficient value aⱼ based on the probability value pⱼ determined for the corresponding one of the random variables Yⱼ. The method may include generating the quasi-standard Gaussian random variable S(n) based on each random variable coefficient value aⱼ determined for each of the random variables Yⱼ to be used and based on a value for each random variable Yⱼ with a probability based on the probability value pⱼ to be used.

The objects and advantages of the embodiments will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 illustrates an example environment related to generating a quasi-standard Gaussian random variable S(n) that closely follows a standard Gaussian distribution;

FIG. 2 illustrates an example computing system that may be configured to generate a quasi-standard Gaussian random variable S(n);

FIG. 3 illustrates a flowchart of an example method of generating a quasi-standard Gaussian random variable S(n);

FIGS. 4A-4C illustrate a flowchart of an example method to generate an optimized quasi-standard Gaussian random variable OS(n);

FIG. 5 illustrates a graphical representation of an example probability distribution of a cumulative distribution function as a function of variable x for a probability distribution of a standard Gaussian random variable Z and a generated quasi-standard Gaussian random variable S(n);

FIG. 6 illustrates a graphical representation of simulations of example tail differences of probability M2 and central difference of probability M1 as a function of a number n of random variables Yⱼ to be used; and

FIG. 7 illustrates a graphical representation of a simulation of a probability density function as a function of variable x.

### DESCRIPTION OF EMBODIMENTS

In some instances a method of statistical analysis may use a random variable that follows a Gaussian distribution (e.g., a Gaussian random variable) to perform statistical analysis. The Gaussian random variable may be obtained by a Gaussian random variable generator.

The Gaussian random variable may be used to assist with statistical eye simulation of signal integrity analysis for a high speed interconnect. Likewise, the Gaussian random variable may be used for various Monte Carlo simulations. Alternatively or additionally, the Gaussian random variable may be used for statistical static timing analysis in a CAD.

In some instances, the Gaussian random variable may be generated to follow a standard Gaussian distribution. Some Gaussian random variable generators may generate the Gaussian random variable so as to closely follow the standard Gaussian distribution at the cost of taking a longer period of time to generate the Gaussian random variable. Other Gaussian random variable generators may generate the Gaussian random variable quickly but at the cost of generating the Gaussian random variable so as not to closely follow the standard Gaussian distribution. Additionally, some Gaussian random variable generators may follow a Gaussian distribution accurately for some standard events and may follow a Gaussian distribution less accurately for some rare events.

According to one or more embodiments described in the present disclosure, a Gaussian random variable generator may quickly generate a quasi-standard Gaussian random variable S(n) that closely follows the standard Gaussian distribution. The quasi-standard Gaussian random variable S(n) may be generated based on a random variable set {Yⱼ}ⱼ₌₁ⁿ, a first parameter para1, a second parameter para2, a number n of random variables in the random variable set {Yⱼ}ⱼ₌₁ⁿ to be used, a probability value pⱼ, and a random variable coefficient aⱼ.

Embodiments of the present disclosure are explained with reference to the accompanying drawings.

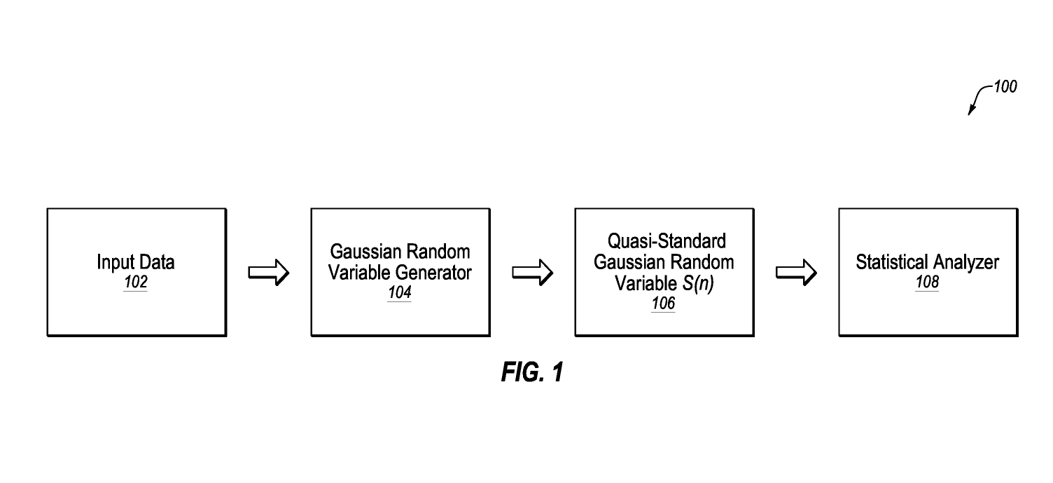

FIG. 1 illustrates an example environment 100 related to generating a quasi-standard Gaussian random variable S(n) 106 that closely follows a standard Gaussian distribution, arranged in accordance with at least one embodiment described herein. The environment 100 may include a Gaussian random variable generator 104 configured to receive input data 102. The Gaussian random variable generator 104 may also be configured to output the quasi-standard Gaussian random variable S(n) 106, which may be based on the input data 102. The quasi-standard Gaussian random variable S(n) 106 may be received by a statistical analyzer 108 to be used for statistical analysis. Additionally or alternatively, the Gaussian random variable generator 104 may be configured to output a Gaussian random variable Z(μ,σ) with a mean μ and a standard deviation a from the quasi-standard Gaussian random variable S(n) 106 by scaling the quasi-standard Gaussian random variable S(n) 106. For example the scaling may be performed following σS(n) plus μ→Z(μ, σ). Variable μ may be the mean of the Gaussian random variable Z(μ,σ) and variable σ may be the standard deviation from the quasi-standard Gaussian random variable S(n) 106 of the Gaussian random variable Z(μ,σ).

The Gaussian random variable generator 104 may include code and routines configured to enable a computing device to generate the quasi-standard Gaussian random variable S(n) 106. Additionally or alternatively, the Gaussian random variable generator 104 may be implemented using hardware including a processor, a microprocessor (e.g., to perform or control performance of one or more operations), a field-programmable gate array (FPGA), or an application-specific integrated circuit (ASIC). In some other instances, the Gaussian random variable generator 104 may be implemented using a combination of hardware and software. In the present disclosure, operations described as being performed by the Gaussian random variable generator 104 may include those which the Gaussian random variable generator 104 may direct a corresponding device or system to perform.

The Gaussian random variable generator 104 may be configured to perform a series of operations with respect to the input data 102 that may be used to generate the quasi-standard Gaussian random variable S(n) 106. For example the Gaussian random variable generator 104 may be configured to obtain a random variable set {Yⱼ}ⱼ₌₁ⁿ of random variables Yⱼ from the input data 102. In some embodiments, the random variable set {Yⱼ}ⱼ₌₁ⁿ may include a sequence of random variables Yⱼ. Each random variable Yⱼ included in the random variable set {Yⱼ}ⱼ₌₁ⁿ may have a value of −1, 1, or 0. Each random variable Yⱼ included in the random variable set {Yⱼ}ⱼ₌₁ⁿ may be independent of each other. Additionally or alternatively, each random variable Yⱼ may not be identically distributed with respect to each other.

In some embodiments, the Gaussian random variable generator 104 may be configured to obtain a first parameter para1 and a second parameter para2 from the input data 102. In some embodiments, the first parameter para1 and the second parameter para2 included in the input data 102 may be randomly generated by a random number generator. Additionally or alternatively, the first parameter para1 and the second parameter para2 included in the input data 102 may be provided by a user or obtained from another source.

In some embodiments, the Gaussian random variable generator 104 may be configured to obtain from the input data 102 a number n of random variables Yⱼ of the random variable set {Yⱼ}ⱼ₌₁ⁿ to be used to generate the quasi-standard Gaussian random variable S(n) 106. In some embodiments, a value of the number n of random variables Yⱼ to be used may be between 40 and 80, or less than 40 or more than 80 in other embodiments. The number n of random variables Yⱼ to be used may determine speed and/or accuracy at which the Gaussian random variable generator 104 generates the quasi-standard Gaussian random variable S(n) 106. For example, if the number n of random variables Yⱼ to be used is small, the speed at which the Gaussian random variable generator 104 generates the quasi-standard Gaussian random variable S(n) 106 may be relatively quicker than if the number n of random variables Yⱼ to be used is large. In another example, if the number n of random variables Yⱼ to be used is large, the quasi-standard Gaussian random variable S(n) 106 may more accurately follow the standard Gaussian distribution than if the number of n of random variables Yⱼ to be used is small.

In some embodiments, the Gaussian random variable generator 104 may be configured to determine, for each of the random variables Yⱼ, a probability value pⱼ. The probability value pⱼ may represent a probability that a value for a corresponding one of the random variables Yⱼ is equal to 1, −1, or 0. The probability value pⱼ may be a value between 0 and 1. The probability that the corresponding one of the random variables Yⱼ is 1 may be equal to the probability value pⱼ. Likewise, the probability that the corresponding one of the random variables Yⱼ is −1 may be equal to the probability value pⱼ. Additionally or alternatively, the probability that the corresponding one of the random variables Yⱼ is 0 may be equal to 1−2pⱼ.

In some embodiments, the probability value pⱼ may be determined as defined in equation 1:

$${p}_{j} = para 2 \times {( \frac{j + 1}{n + 1} )}^{\frac{1}{para 1}} , \qquad Equation 1$$

Additionally or alternatively, in some embodiments, the probability value pⱼ may be determined as defined in equation 2:

$${p}_{j} = exp ( - para 1 \times \frac{j + 1}{n + 1} + para 2 ) , \qquad Equation 2$$

In equations 1 and 2, para1 may be the first parameter, para2 may be the second parameter and para2 may be greater than zero, n may be the number of random variables Yⱼ to be used, and j may be a counter that is initialized to be equal to zero and is incremented by one each time a probability value pⱼ is determined. For example, if the random variable Yⱼ is a first random variable (e.g., Yⱼ=Y₀) the value of the counter j may be equal to 0. In another example, if the random variable Yⱼ is the third random variable (e.g., Yⱼ=Y₂) the value of the counter j may be equal to 2. The counter j may be used to determine when the Gaussian random variable generator 104 stops determining the probability value pⱼ. The Gaussian random variable generator 104 may stop determining the probability value pⱼ when the counter j is equal to or greater than the number n of random variables Yⱼ to be used.

In yet another embodiment, the probability value pⱼ may be determined using a random number generator. In these or other embodiments, the first parameter para1 and the second parameter para2 may be an upper and a lower bound for a range of values of the random numbers generated for the probability value pⱼ. In these embodiments, para2 may be greater than zero.

In some embodiments, a maximum value pₘₐₓ for the probability factor pⱼ may be determined based on a predetermined setting. In these and other embodiments, the maximum value pₘₐₓ for the probability factor pⱼ may be provided by a user or obtained from another source. The maximum value pₘₐₓ may be determined to ensure variety in the random variables Yⱼ. For example, the maximum value pₘₐₓ may be set to 0.5. In another example, the maximum value pₘₐₓ for the probability value pⱼ may be set to 0.25, or some other value between 0 and 0.5.

In some embodiments, if the probability value pⱼ exceeds a critical value p_{critical}, the probability value pⱼ may be set to the maximum value pₘₐₓ. For example, if the critical value p_{critical} is set to 0.5, the maximum value pₘₐₓ is set to 0.5, and the probability value pⱼ is equal to 0.7, the Gaussian random variable generator 104 may change the probability value pⱼ to be equal to 0.5 (e.g., equal to the maximum value pₘₐₓ). In another example, if the critical value p_{critical} is set to 0.5, the maximum value pₘₐₓ is set to 0.25, and the probability value pⱼ is equal to 0.7, the Gaussian random variable generator 104 may change the probability value pⱼ to be equal to 0.25 (e.g., equal to the maximum value pₘₐₓ).

In an example embodiment, the maximum value pₘₐₓ may be set to 0.25 and the critical value p_{critical} may be set to 0.25. If the probability value pⱼ exceeds 0.25, the probability value pⱼ is set to be equal to 0.25. In this example, the probability value pⱼ that the corresponding random variable Yⱼ is 1 is equal to 0.25 (e.g., 25%). Likewise, the probability value pⱼ that the corresponding random variable Yⱼ is −1 is equal to 0.25. Additionally, the probability value pⱼ that the corresponding random variable Yⱼ is 0 is equal to 1−2(0.25)=1−0.5=0.5. Adding up the probability values pⱼ that the corresponding random variable Yⱼ is 1, −1, or 0 equals 1 (e.g., 0.25+0.25+0.5=1) which is the equivalent of a one hundred percent probability.

In some embodiments, the Gaussian random variable generator 104 may be configured to determine, for each of the random variables Yⱼ, a random variable coefficient aⱼ. The random variable coefficient aⱼ may be determined as defined in equation 3:

$${a}_{j} = \sqrt{\frac{1}{2 {p}_{j}}} , \qquad Equation 3$$

In equation 3, pⱼ may be the probability value determined as discussed above. For example, if the probability value pⱼ is equal to 0.25 the random variable coefficient aⱼ is equal to 1.41 (e.g., \sqrt{2}).

Additionally or alternatively, after assigning the values of random variable coefficient aⱼ, if the probability value pⱼ exceeds a critical value p_{critical}, the probability value pⱼ may be set to the maximum value pₘₐₓ. For example, if the critical value p_{critical} is set to 0.5, the maximum value pₘₐₓ is set to 0.5, and the probability value pⱼ is equal to 0.7, the Gaussian random variable generator 104 may change the probability value pⱼ to be equal to 0.5 (e.g., equal to the maximum value pₘₐₓ). In another example, if the critical value p_{critical} is set to 0.5, the maximum value pₘₐₓ is set to 0.25, and the probability value pⱼ is equal to 0.7, the Gaussian random variable generator 104 may change the probability value pⱼ to be equal to 0.25 (e.g., equal to the maximum value pₘₐₓ).

In some embodiments, the Gaussian random variable generator 104 may be configured to generate the quasi-standard Gaussian random variable S(n) 106. The quasi-standard Gaussian random variable S(n) 106 may be generated as defined in equation 4:

$$S ( n ) = \frac{{Σ}_{j = 0}^{n - 1} {a}_{j} {Y}_{j}}{\sqrt{var ( {Σ}_{j = 0}^{n - 1} {a}_{j} {Y}_{j} )}} , \qquad Equation 4$$

In equation 4, aⱼ may be the random variable coefficient determined as discussed above for each of the random variables Yⱼ and Yⱼ may be a value for a corresponding random variable Yⱼ, which the value of Yⱼ may be equal to 1, 0, or −1 with probability pⱼ, 1−2(pⱼ), and pⱼ respectively as discussed above. The probability distribution of the quasi-standard Gaussian random variable S(n) 106 may closely follow the standard Gaussian distribution since the probability value pⱼ is limited by either or both of pₘₐₓ or p_{critical} as discussed above, which subsequently limits the random variable coefficient aⱼ.

In some embodiments, the Gaussian random variable generator 104 may be configured to obtain, from the input data 102, a variable α that determines a standard of absolute error between the generated quasi-standard Gaussian random variable S(n) 106 and a standard Gaussian random variable Z. In some embodiments, the variable α included in the input data 102 may be provided by a user or obtained from another source. The variable α may include a value between one and ten. The accuracy of the generated quasi-standard Gaussian random variable S(n) 106 may increase as the value of the variable α increases. For example, the accuracy of the quasi-standard Gaussian random variable S(n) 106 when the value of variable α is two may be relatively lower than when the value of variable α is ten. Additionally or alternatively, as the value of a increases a higher standard of accuracy of the generated quasi-standard Gaussian random variable S(n) 106 in the central part of the probability distribution may subsequently lower a central difference of probability M1 in equation 5 as discussed below. For example, standard of accuracy of the quasi-standard Gaussian random variable S(n) 106 in a central portion of the probability distribution when the value of variable α is two may be lower than when the value of variable α is ten.

In some embodiments, the Gaussian random variable generator 104 may be configured to obtain from the input data 102 a variable β that determines a first boundary of a standard of relative error between the generated quasi-standard Gaussian random variable S(n) 106 and the standard Gaussian random variable Z. Additionally or alternatively, the variable β may determine the first boundary of a standard of a log of relative error between the generated quasi-standard Gaussian random variable S(n) 106 and the standard Gaussian random variable Z. Likewise, the Gaussian random variable generator 104 may be configured to obtain a variable γ that determines a second boundary of the standard of relative error between the generated quasi-standard Gaussian random variable S(n) 106 and the standard Gaussian random variable Z. Additionally or alternatively, the variable γ may determine the second boundary of a standard of a log of relative error between the generated quasi-standard Gaussian random variable S(n) 106 and the standard Gaussian random variable Z. In some embodiments, the variable β and the variable γ included in the input data 102 may be provided by a user or obtained from another source.

In some embodiments, the variable β may have values between two and ten and the variable γ may have values between two and β. The accuracy of the generated quasi-standard Gaussian random variable S(n) 106 may increase as the values of the variable β and the variable γ increase. For example, if the generated quasi-standard Gaussian random variable S(n) 106 is to closely follow the standard Gaussian distribution, the variable β may be set to six or seven. Additionally or alternatively, as the value of β increases a higher standard of accuracy of the generated quasi-standard Gaussian random variable S(n) 106 in the left tail or right tail of the probability distribution may subsequently lower the left difference of probability LM2 and right difference of probability RM2 as discussed below. For example, the value of variable β may be set to six or seven if a higher standard of accuracy of tails part of Gaussian distribution is required.

In some embodiments, the Gaussian random variable generator 104 may be configured to determine the central difference of probability M1 between the probability distribution of the generated quasi-standard Gaussian random variable S(n) 106 and the standard Gaussian distribution. The central difference of probability M1 may be determined as defined by equation 5:

M1(α)=max_{|x|≤α}|P(Z<x)−P(S(n)<x)|, Equation 5

In equation 5, x may be any value between −α and α, S(n) may be the generated quasi-standard Gaussian random variable S(n) 106, Z may be the standard Gaussian random variable, and a may be a value that determines the standard of absolute error between the generated quasi-standard Gaussian random variable S(n) 106 and the standard Gaussian random variable Z.

The central difference of probability M1 may represent a difference between the distribution of the generated quasi-standard Gaussian random variable S(n) 106 and the standard Gaussian distribution in a central portion of a cumulative distribution function. In some embodiments, the central difference of probability M1 may represent the maximum of absolute differences between a cumulative probability function of the generated quasi-standard Gaussian random variable S(n) 106 less than the value of variable x and of the standard Gaussian random variable Z less than the same value of variable x among values of x between −α and α. For example, the values for the variable x in the central difference probability may be bound between −2 and 2, where a is set to 2. The central difference of probability M1 may be a smaller value when the generated quasi-standard Gaussian random variable S(n) 106 closely behaves as the standard Gaussian random variable Z. Additionally or alternatively, a smaller value for the central difference of probability M1 and a larger value for the variable α may correspond to the generated quasi-standard Gaussian random variable S(n) 106 closely behaving as the standard Gaussian random variable Z as discussed above.

In some embodiments, the Gaussian random variable generator 104 may be configured to determine the left difference of probability LM2 and the right difference of probability RM2. The left difference of probability LM2 may represent a difference between the distribution of the generated quasi-standard Gaussian random variable S(n) 106 and the standard Gaussian random variable Z in a left portion or left tail of the cumulative distribution function. Additionally or alternatively, the left difference of probability LM2 may represent a maximum of a log of the relative difference between a cumulative probability function of the generated quasi-standard Gaussian random variable S(n) 106 less than the value for variable x and that of the standard Gaussian random variable Z less than the value for variable x for values of variable x between −β and −γ. The left difference of probability LM2 may be determined as defined in equation 6:

$$LM 2 ( β , γ ) = {max}_{- β \leq x \leq - γ} \frac{\vert {log}_{10} P ( Z < x ) - {log}_{10} P ( S ( n ) < x ) \vert}{- {log}_{10} P ( Z < x )} , \qquad Equation 6$$

The left portion or left tail of the cumulative distribution function may correspond to the lower bound of the central portion of the cumulative distribution.

The right difference of probability RM2 may represent a difference between the distribution of the generated quasi-standard Gaussian random variable S(n) 106 and the standard Gaussian random variable Z in a right portion or right tail of the cumulative distribution function. Additionally or alternatively, the left difference of probability LM2 may represent a maximum of a log of the relative difference between a cumulative probability function of the generated quasi-standard Gaussian random variable S(n) 106 larger than the value for variable x and that of the standard Gaussian random variable Z larger than the value for variable x for values of variable x between γ and β. The right difference of probability RM2 may be determined as defined in equation 7:

$$RM 2 ( β , γ ) = {max}_{γ \leq x \leq β} \frac{\vert {log}_{10} P ( Z > x ) - {log}_{10} P ( S ( n ) > x ) \vert}{- {log}_{10} P ( Z > x )} , \qquad Equation 7$$

In equations 6 and 7, x may be any value between −β and −γ inclusively and between γ and β inclusively respectively, S(n) may be the generated quasi-standard Gaussian random variable S(n) 106, Z may be the standard Gaussian random variable, β may be the value that determines the first boundary of the standard of relative error or the standard of a log of the relative error between the generated quasi-standard Gaussian random variable S(n) 106 and the standard Gaussian random variable Z, and γ may be the value that determines the second boundary of the standard of relative error or the standard of a log of the relative error between the generated quasi-standard Gaussian random variable S(n) 106 and the standard Gaussian random variable Z. The right portion or right tail of the cumulative distribution function may correspond to the upper bound of the central portion of the cumulative distribution. For example, as discussed above, the upper bound of the central portion may be equal to 2, in this instance, the right portion or right tail may correspond to any and all values of variable x that are greater than 2.

In some embodiments, the Gaussian random variable generator 104 may be configured to determine a tail difference of probability M2. The tail difference of probability M2 may represent the difference between the distribution of the generated quasi-standard Gaussian random variable S(n) 106 and the standard Gaussian random variable Z in both the right and left portions or tails of the cumulative distribution function. The tail difference of probability M2 may be determined as defined in equation 8:

M2(β,γ)=max{LM2(β,γ),RM2(β,γ)}, Equation 8

In equation 8, LM2 may be the left difference of probability, RM2 may be the right difference of probability, β may be the value that determines the first boundary of the standard of relative error or the standard of a log of the relative error between the generated quasi-standard Gaussian random variable S(n) 106 and the standard Gaussian random variable Z, and γ may be the value that determines the second boundary of the standard of relative error or the standard of a log of the relative error between the generated quasi-standard Gaussian random variable S(n) 106 and the standard Gaussian random variable Z. Additionally or alternatively, the tail difference of probability M2 may be determined using sampling methods such as importance sampling.

A small tail difference of probability M2 may indicate that the generated quasi-standard Gaussian random variable S(n) 106 behaves similarly to the standard Gaussian random variable Z outside the central portion of the cumulative distribution function.

In some embodiments, the Gaussian random variable generator 104 may be configured to determine an updated first parameter Opara1 and an updated second parameter Opara2. The updated first parameter Opara1 and the updated second parameter Opara2 may be determined to reduce the tail difference of probability M2 without modifying the number n of random variables Yⱼ to be used. The updated first parameter Opara1 and the updated second parameter Opara2 may be determined according to any suitable technique. For example, the updated first parameter Opara1 and the updated second parameter Opara2 may be determined using a Newton's method for optimization algorithm.

In some embodiments, the Gaussian random variable generator 104 may be configured to determine, for each of the random variables Yⱼ, an updated probability value opⱼ and an updated random variable coefficient oaⱼ. The methods and equations for determining the updated probability value opⱼ and the updated random variable coefficient oaⱼ may be similar to the methods and equations (e.g., equations 1, 2, and 3) discussed above with relation to the probability value pⱼ and the random variable coefficient aⱼ. The updated first parameter Opara1 and the updated second parameter Opara2 may be used in equations 1 and 2 instead of the first parameter para1 and the second parameter para2. Likewise, the updated probability value opⱼ may be used in equation 3 instead of the probability value pⱼ.

In some embodiments, the Gaussian random variable generator 104 may be configured to generate an updated quasi-standard Gaussian random variable OS(n) 106. The methods and equations for generating the updated quasi-standard Gaussian random variable OS(n) 106 may be similar to the methods and equations (e.g., equation 4) discussed above with relation to the generated quasi-standard Gaussian random variable S(n) 106. The updated random variable coefficient oaⱼ and the updated probability value opⱼ may be used in equation 4 instead of the random variable coefficient aⱼ and the probability value pⱼ.

In some embodiments, the Gaussian random variable generator 104 may be configured to determine an updated left difference of probability OLM2 and an updated right difference of probability ORM2. The methods and equations for determining the updated left difference of probability OLM2 and the updated right difference of probability ORM2 may be similar to the methods and equations (e.g., equations 6 and 7) discussed above with relation to the left difference of probability LM2 and the right difference of probability RM2. The updated quasi-standard Gaussian random variable OS(n) 106 may be used in equations 6 and 7 instead of the generated quasi-standard Gaussian random variable S(n) 106.

In some embodiments, the Gaussian random variable generator 104 may be configured to determine an updated tail difference of probability OM2. The methods and equations for determining the updated tail difference of probability OM2 may be similar to the methods and equations (e.g., equation 8) discussed above with relation to the tail difference of probably M2. The updated left difference of probability OLM2 and the updated right difference of probability ORM2 may be used in equation 8 instead of the left difference of probability LM2 and the right difference of probability RM2.

In some embodiments, the Gaussian random variable generator 104 may be configured to determine a difference between the updated tail difference of probability OM2 and the tail difference of probability M2. The difference between the updated tail difference of probability OM2 and the tail difference of probability M2 may be used to determine if a probability distribution of the updated generated quasi-standard Gaussian random variable OS(n) 106 is approaching the standard Gaussian distribution as compared to the generated quasi-standard Gaussian random variable S(n) 106. The Gaussian random variable generator 104 may be configured to repeat the update process until a minimum number iteration of quasi-standard Gaussian random variables S(n) 106 have been generated and the difference between the updated tail difference of probability OM2 (e.g., a recently determined updated tail difference of probability OM2) and the tail difference of probability M2 or a previously determined updated tail difference of probability OM2 is below a probability threshold value. For example, a minimum number iteration of quasi-standard Gaussian random variables S(n) 106 to be generated may be 100 and the threshold value may be 0.01, which may indicate that the probability distribution of the updated generated quasi-standard Gaussian random variable OS(n) 106 accurately follows the standard Gaussian distribution. Additionally, the Gaussian random variable generator 104 may be configured to repeat the update process until a maximum number iterationh of quasi-standard Gaussian random variables S(n) 106 have been generated. In some embodiments, the maximum number iterationh of quasi-standard Gaussian random variables S(n) 106 to be generated may be equal to 500.

In some embodiments, the Gaussian random variable generator 104 may be configured to transmit the generated quasi-standard Gaussian random variable S(n) 106 and/or updated generated quasi-standard Gaussian random variable OS(n) 106 to the statistical analyzer 108. The statistical analyzer 108 may use the generated quasi-standard Gaussian random variable S(n) 106 and/or updated generated quasi-standard Gaussian random variable OS(n) 106 for various statistical analysis methods. For example, the statistical analyzer 108 may use the generated quasi-standard Gaussian random variable S(n) 106 and/or updated generated quasi-standard Gaussian random variable OS(n) 106 for statistical eye simulation of signal integrity analysis for high speed interconnects. In another example, the statistical analyzer 108 may use the generated quasi-standard Gaussian random variable S(n) 106 and/or updated generated quasi-standard Gaussian random variable OS(n) 106 for statistical static timing analysis in a CAD. In yet another example, the statistical analyzer may use the generated quasi-standard Gaussian random variable S(n) 106 and/or updated generated quasi-standard Gaussian random variable OS(n) 106 for a Monte Carlo method of statistical analysis. The above listed examples represent only a few possible example uses with respect to the present disclosure.

Modifications, additions, or omissions may be made to FIG. 1 without departing from the scope of the present disclosure. For example, the environment 100 may include more or fewer elements than those illustrated and described in the present disclosure. In some embodiments operations may be performed in a different order from what is described above.

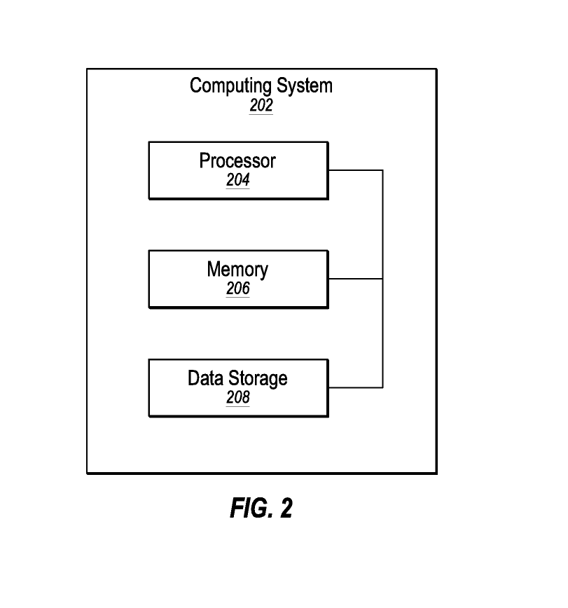

FIG. 2 illustrates an example computing system that may be configured to generate a quasi-standard Gaussian random variable S(n). The computing system 202 may be configured to implement or direct one or more operations associated with a Gaussian random variable generator (e.g., the Gaussian random variable generator 104 of FIG. 1). The computing system 202 may include a processor 204, a memory 206, and a data storage 208. The processor 204, the memory 206, and the data storage 208 may be communicatively coupled, e.g., via a communication bus.

In general, the processor 204 may include any suitable special-purpose or general-purpose computer, computing entity, or processing device including various computer hardware or software modules and may be configured to execute instructions stored on any applicable computer-readable storage media. For example, the processor 204 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 2, the processor 204 may include any number of processors configured to, individually or collectively, perform or direct performance of any number of operations described in the present disclosure. Additionally, one or more of the processors may be present on one or more different electronic devices, such as different servers.

In some embodiments, the processor 204 may be configured to interpret and/or execute program instructions and/or process data stored in the memory 206, the data storage 208, or the memory 206 and the data storage 208. In some embodiments, the processor 204 may fetch program instructions from the data storage 208 and load the program instructions in the memory 206. After the program instructions are loaded into memory 206, the processor 204 may execute the program instructions.

For example, in some embodiments, the Gaussian random variable generator may be included in the data storage 208 as program instructions. The processor 204 may fetch the program instructions of the Gaussian random variable generator from the data storage 208 and may load the program instructions of the Gaussian random variable generator in the memory 206. After the program instructions of the Gaussian random variable generator are loaded into the memory 206, the processor 204 may execute the program instructions such that the computing system may implement the operations associated with the Gaussian random variable generator as directed by the instructions.

The memory 206 and the data storage 208 may include computer-readable storage media for carrying or having computer-executable instructions or data structures stored thereon. Such computer-readable storage media may include any available media that may be accessed by a general-purpose or special-purpose computer, such as the processor 204. By way of example such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store particular program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 204 to perform a certain operation or group of operations.

Modifications, additions, or omissions may be made to the computing system 202 without departing from the scope of the present disclosure. For example, in some embodiments, the computing system 202 may include any number of other components that may not be explicitly illustrated or described.

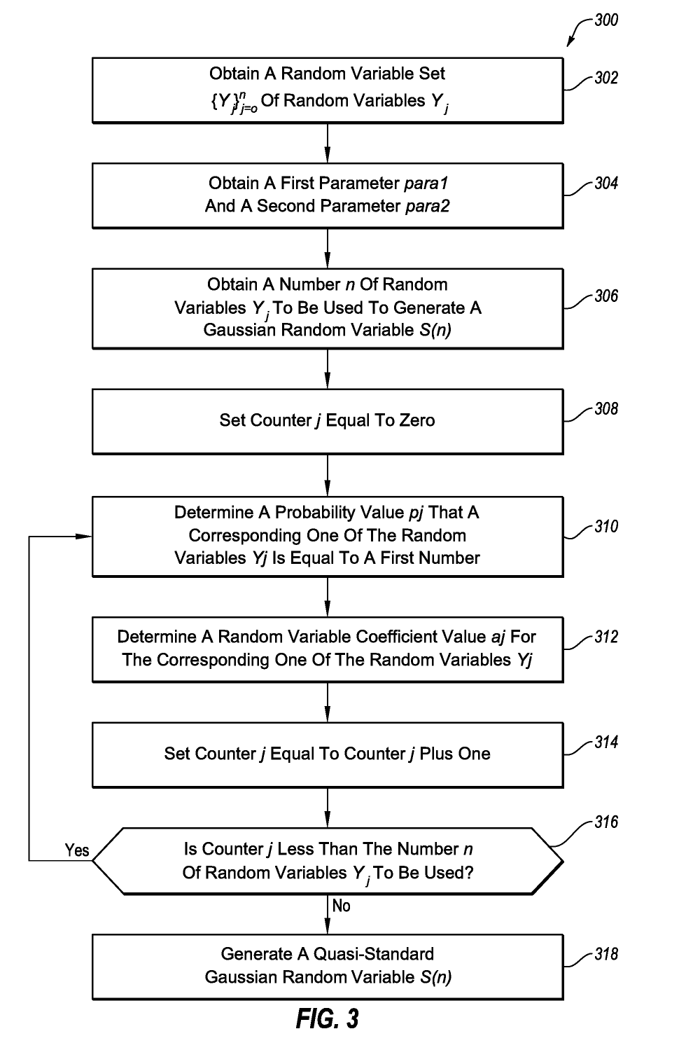

FIG. 3 illustrates a flowchart of an example method of generating a quasi-standard Gaussian random variable S(n), according to at least one embodiment described in the present disclosure. The method 300 may be performed by any suitable system, apparatus, or device with respect to input data (e.g., the input data 102 of FIG. 1) of the software program. For example, the Gaussian random variable generator 104 of FIG. 1 or the computing system 202 of FIG. 2 (e.g., as directed by a Gaussian random variable generator) may perform or direct performance of one or more of the operations associated with the method 300 with respect to the software program. Although illustrated with discrete blocks, the steps and operations associated with one or more of the blocks of the method 300 may be divided into additional blocks, combined into fewer blocks, or eliminated, depending on the particular implementation.

The method 300 may include a block 302, at which a random variable set {Yⱼ}ⱼ₌₁ⁿ of random variables Yⱼ may be obtained. At block 304, a first parameter para1 and a second parameter para2 may be obtained. At block 306, a number n of random variables Yⱼ in the random variable set {Yⱼ}ⱼ₌₁ⁿ to be used to generate the quasi-standard Gaussian random variable S(n) may be obtained. At block 308, a counter j may be set equal to zero.

At block 310, a probability value pⱼ that a corresponding one of the random variables Yⱼ is equal to a first number may be determined. In some embodiments, the probability value pⱼ may be based on the first parameter para1 and the second parameter para2 as discussed above in relation to equations 1 and 2. Additionally or alternatively, the probability value pⱼ may be a random number generated by a random number generator and the first parameter para1 and the second parameter para2 may be used as bounds for the random numbers generated for the probability value pⱼ.

At block 312, a random variable coefficient a₁ may be determined. The random variable coefficient aⱼ may be based on the probability value pⱼ for the corresponding one of the random variables Yⱼ as discussed above in relation to equation 3. At block 314, the counter j may be set equal to the counter j plus one (e.g., j=j+1).

At block 316, it may be determined whether the counter j is less than the number n of random variables Yⱼ to be used. In response to determining that the counter j is less than the number n of random variables Yⱼ to be used, the method 300 may return to block 310. In some embodiments, the method 300 may repeat the operations of blocks 310, 312, and 314 until the probability value pⱼ and the random variable coefficient aⱼ have been determined for each random variable Yⱼ to be used.

In response to determining that the counter j is equal to or greater than the number n of random variables Yⱼ to be used, the method 300 may proceed to block 318. At block 318, the quasi-standard Gaussian random variable S(n) may be generated. The generated quasi-standard Gaussian random variable S(n) may be based on the random variable coefficient aⱼ for each of the random variables Yⱼ to be used and based on a value for each random variable Yⱼ with a probability based on the probability value pⱼ to be used as discussed above in relation to equation 4.

Modifications, additions, or omissions may be made to the method 300 without departing from the scope of the present disclosure. For example, the operations of method 300 may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the disclosed embodiments.

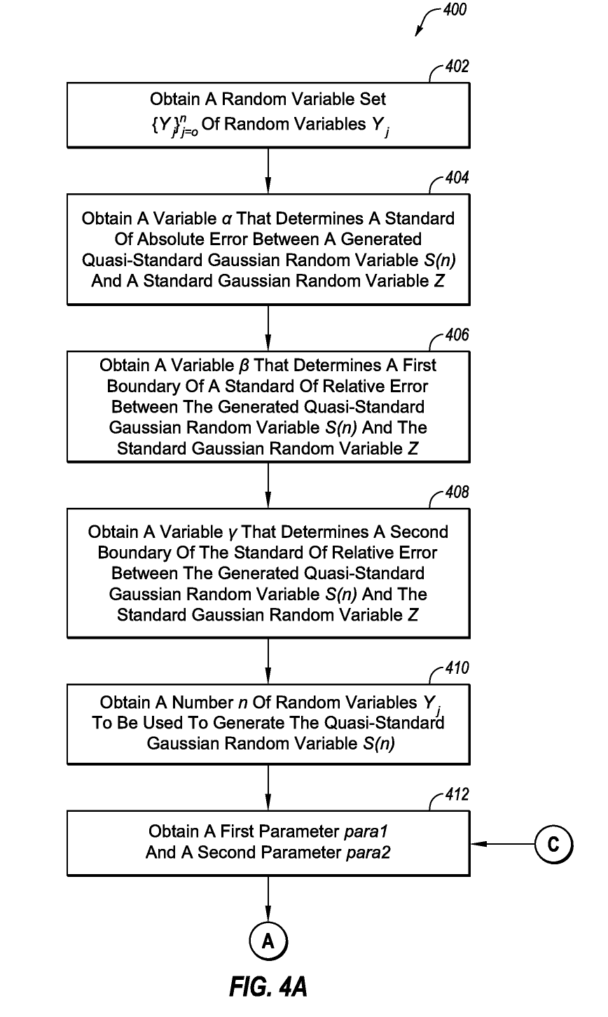

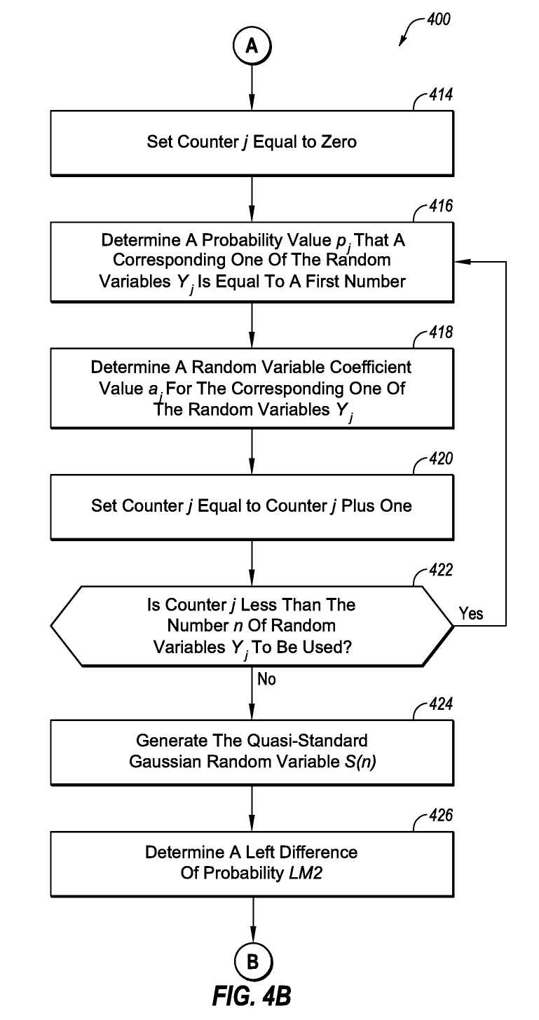

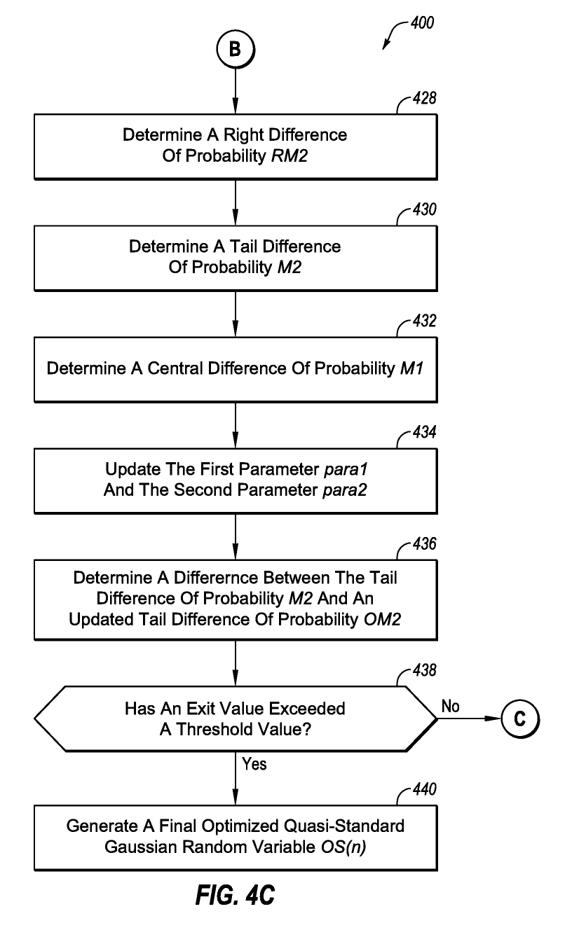

FIGS. 4A-4C illustrate a flowchart of an example method 400 to generate an optimized quasi-standard Gaussian random variable OS(n), according to at least one embodiment described in the present disclosure. The method 400 may be performed by any suitable system, apparatus, or device with respect to input data. For example, the Gaussian random variable generator 104 of FIG. 1 or the computing system 202 of FIG. 2 (e.g., as directed by a Gaussian random variable generator) may perform or direct performance of one or more of the operations associated with the method 400 with respect to input data. Although illustrated with discrete blocks, the steps and operations associated with one or more of the blocks of the method 400 may be divided into additional blocks, combined into fewer blocks, or eliminated, depending on the particular implementation.

Referring to FIG. 4A, the method 400 may begin at block 402, where a random variable set {Yⱼ}ⱼ₌₁ⁿ of random variables Yⱼ may be obtained. At block 404, a variable α that determines a standard of absolute error between the generated quasi-standard Gaussian random variable S(n) and a standard Gaussian random variable Z may be obtained. At block 406, a variable β that determines a first boundary of a standard of relative error or the standard of a log of the relative error between the generated quasi-standard Gaussian random variable S(n) and the standard Gaussian random variable Z may be obtained. At block 408, a variable γ that determines a second boundary of the standard of relative error or the standard of a log of the relative error between the generated quasi-standard Gaussian random variable S(n) and the standard Gaussian random variable Z may be obtained.

At block 410, a number n of random variables Yⱼ in the random variable set {Yⱼ}ⱼ₌₁ⁿ to be used to generate the quasi-standard Gaussian random variable S(n) may be obtained. At block 412, a first parameter para1 and a second parameter para2 may be obtained. Referring to FIG. 4B, at block 414, a counter j may be set equal to zero.

At block 416, a probability value pⱼ that a corresponding one of the random variables Yⱼ is equal to a first number may be determined. In some embodiments, the probability value pⱼ may be based on the first parameter para1 and the second parameter para2 as discussed above in relation to equations 1 and 2. Additionally or alternatively, the probability value pⱼ may be a random number generated by a random number generator and the first parameter para1 and the second parameter para2 may be used as bounds for the random numbers generated for the probability value pⱼ.

At block 418, a random variable coefficient aⱼ for the corresponding one of the random variables Yⱼ may be determined. The random variable coefficient aⱼ may be based on the probability value pⱼ for the corresponding one of the random variables Yⱼ as discussed above in relation to equation 3.

At block 420, the counter j may be set equal to the counter j plus one (e.g., j=j+1). At block 422, it may be determined whether the counter j is less than the number n of random variables Yⱼ to be used. In response to determining that the counter j is less than the number n of random variables Yⱼ to be used, the method 400 may return to block 416. In some embodiments, the method 400 may repeat the operations of blocks 416, 418, 420, and 422 until the probability value pⱼ and the random variable coefficient aⱼ have been determined for each random variable Yⱼ to be used.

In response to determining that the counter j is equal to or greater than the number n of random variables Yⱼ to be used, the method 400 may proceed to block 424. At block 424, the quasi-standard Gaussian random variable S(n) may be generated. The generated quasi-standard Gaussian random variable S(n) may be based on each random variable coefficient aⱼ for each of the random variables Yⱼ to be used and based on a value for each random variable Yⱼ with a probability based on the probability value pⱼ to be used as discussed above in relation to equation 4.

At block 426, a left difference of probability LM2 may be determined. The left difference of probability LM2 may be based on the generated quasi-standard Gaussian random variable S(n), the variable γ, the standard Gaussian random variable Z, the variable x generated by a random number generator, and the variable β as discussed above in relation to equation 6. Referring to FIG. 4C, at block 428, a right difference of probability RM2 may be determined. The right difference of probability RM2 may be based on the generated quasi-standard Gaussian random variable S(n), the variable γ, the standard Gaussian random variable Z, and the variable β as discussed above in relation to equation 7. At block 430, a tail difference of probability M2 may be determined. The tail difference of probability M2 may be based on the left difference of probability LM2 and the right difference of probability RM2 as discussed above in relation to equation 8. Additionally or alternatively, the tail difference of probability M2 may be based on the maximum between the left difference of probability LM2 and the right difference of probability RM2 as discussed above in relation to equation 8. At block 432, a central difference of probability M1 may be determined. The central difference of probability M1 may be based on the variable x, the generated quasi-standard Gaussian random variable S(n), the standard Gaussian random variable Z, and the variable α as discussed above in relation to equation 5.

At block 434, the first parameter para1 and the second parameter para2 may be updated. The first parameter para1 and the second parameter para2 may be updated so as to reduce the tail difference of probability M2. The first parameter para1 and the second parameter para2 may be updated according to any suitable technique, such as Newton's method. At block 436, a difference between an updated tail difference of probability OM2 and the tail difference of probability M2 may be determined. If an updated tail difference of probability OM2 has not yet been determined, the method 400 may skip block 436. If an updated tail difference of probability OM2 has been determined, the difference between the updated tail difference of probability OM2 and the tail difference of probability M2 or a previously determined updated tail difference of probability OM2 may be used to determine if a probability distribution of the generated quasi-standard Gaussian random variable S(n) is converging towards the probability distribution of the standard Gaussian distribution.

At block 438, it may be determined whether an exit value has exceeded a threshold value. The threshold value may be based on a minimum number iteration of quasi-standard Gaussian random variables S(n) to be generated and the difference between the updated tail difference of probability OM2 and the tail difference of probability M2 or a previously determined updated tail difference of probability OM2 being below a probability threshold value. In some embodiments, a range of the probability threshold value may be greater than 0 and less than 0.01. Likewise, the minimum number iteration of quasi-standard Gaussian random variables S(n) to be generated may be equal to or greater than 100. Additionally or alternatively, the threshold value may be based on a maximum number iterationh of quasi-standard Gaussian random variables S(n) to be generated. In some embodiments, the maximum number iterationh of quasi-standard Gaussian random variables S(n) to be generated may be equal to or greater than 500.

In response to determining that the exit value has not exceeded the threshold value, the method 400 may repeat one or more of the operations of blocks 412, 414, 416, 418, 420, 422, 424, 426, 428, 430, 432, 434, 436, and 438 with one or more updated values. For instance, referring to FIG. 4A, at block 412, an updated first parameter Opara1 and an updated second parameter Opara2 may be obtained instead of the first parameter para1 and the second parameter para2. At block 414, the counter j may be set equal to zero.

Referring to FIG. 4B, at block 416, an updated probability value opⱼ that the corresponding one of the random variables Yⱼ is equal to the first number may be determined instead of the probability value pⱼ. The updated probability value opⱼ may be determined using the updated first parameter Opara1 and the updated second parameter Opara2 instead of the first parameter para1 and the second parameter para2.

At block 418, an updated random variable coefficient oaⱼ for the corresponding one of the random variables Yⱼ may be determined instead of the random variable coefficient aⱼ. The updated random variable coefficient oaⱼ may be based on the updated probability value opⱼ for the corresponding one of the random variables Yⱼ instead of the probability value pⱼ for the corresponding one of the random variables Yⱼ.

At block 420, the counter j may be set equal to the counter j plus one (e.g., j=j+1). At block 422, it may be determined whether the counter j is less than the number n of random variables Yⱼ to be used. In response to determining that the counter j is less than the number n of random variables Yⱼ to be used, the method 400 may return to block 416. In some embodiments, the method 400 may repeat the operations of blocks 416, 418, 420, and 422 until the updated probability value opⱼ and the updated random variable coefficient oaⱼ have been determined for each random variable Yⱼ to be used.

In response to determining that the counter j is equal to or greater than the number n of random variables Yⱼ to be used, the method 400 may proceed to block 424. At block 424, an updated quasi-standard Gaussian random variable OS(n) may be generated instead of the quasi-standard Gaussian random variable S(n). The updated generated quasi-standard Gaussian random variable OS(n) may be based on each updated random variable coefficient oaⱼ for each of the random variables Yⱼ to be used and based on a value for each random variable Yⱼ with a probability based on the updated probability value opⱼ instead of each random variable coefficient aⱼ for each of the random variables Yⱼ to be used.

At block 426, an updated left difference of probability OLM2 may be determined instead of the left difference of probability LM2. The updated left difference of probability OLM2 may be based on the value for variable x generated by a random number generator, the updated generated quasi-standard Gaussian random variable OS(n), the variable γ, the standard Gaussian random variable Z, and the variable β as discussed above in relation to equation 6. Referring to FIG. 4C, at block 428, an updated right difference of probability ORM2 may be determined instead of the right difference of probability RM2. The updated right difference of probability ORM2 may be based on the value for variable x generated by a random number generator, the updated generated quasi-standard Gaussian random variable OS(n), the variable γ, the standard Gaussian random variable Z, and the variable β as discussed above in relation to equation 7.

At block 430, an updated tail difference of probability OM2 may be determined instead of the tail difference of probability M2. The updated tail difference of probability OM2 may be based on the updated left difference of probability OLM2 and the updated right difference of probability ORM2 as discussed above in relation to equation 8. Additionally or alternatively, the updated tail difference of probability OM2 may be based on the maximum between the updated left difference of probability OLM2 and the updated right difference of probability ORM2 as discussed above.

At block 432, an updated central difference of probability OM1 may be determined instead of the central difference of probability M1. The updated central difference of probability OM1 may be based on the updated generated quasi-standard Gaussian random variable OS(n), the variable x, the standard Gaussian random variable Z, and the variable α as discussed above in relation to equation 5. At block 434, the updated first parameter Opara1 and the updated second parameter Opara2 may be updated. At block 436, the difference between the updated tail difference of probability OM2 and a previous tail difference of probability M2 or a previous updated tail difference of probability OM2 may be determined. At block 438, it may be determined whether the exit value has exceeded the threshold value.

In response to determining that the exit value has not exceeded the threshold value, the method 400 may repeat one or more of the operations of blocks 412, 414, 416, 418, 420, 422, 424, 426, 428, 430, 432, 434, 436, and 438 until the exit value has exceeded the threshold value.

In response to determining that the exit value has exceeded the threshold value, the method 400 may proceed to block 440. At block 440, a final optimized quasi-standard Gaussian random variable OS(n) may be generated. The final optimized generated quasi-standard Gaussian random variable OS(n) may be based on each updated random variable coefficient aⱼ for each of the random variables Yⱼ to be used and based on a value for each random variable Yⱼ with a probability based on the updated probability value opⱼ to be used using the updated first parameter Opara1 and the updated second parameter Opara2 that caused the exit value to exceed the threshold value.

Modifications, additions, or omissions may be made to the method 400 without departing from the scope of the present disclosure. For example, the operations of method 400 may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the disclosed embodiments.

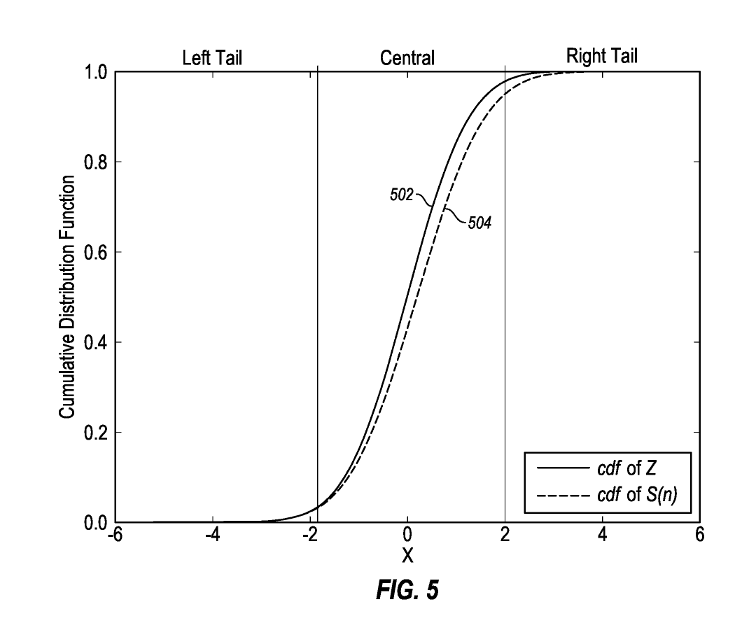

FIG. 5 illustrates a graphical representation of an example probability distribution of a cumulative distribution function as a function of variable x for a probability distribution of a standard Gaussian random variable Z and a generated quasi-standard Gaussian random variable S(n) generated in accordance with at least one embodiment described herein. Curve 502 represents the probability distribution of the standard Gaussian random variable Z over a range of the variable x. Curve 504 represents the probability distribution of the generated quasi-standard Gaussian random variable S(n) over the range of the variable x. A central portion of the range of the variable x corresponds to values of the variable x that are greater than or equal to −2 and less than or equal to 2. A left portion (or “Left Tail” in FIG. 5) of the range of the variable x corresponds to all values of the variable x that are less than −2. Likewise, a right portion (or “Right Tail” in FIG. 5) of the range of the variable x corresponds to all values of the variable x that are greater than 2.

A difference between the curve 504 representing the cumulative distribution function of the generated quasi-standard Gaussian random variable S(n) and the curve 502 that represents the cumulative distribution function of the standard Gaussian random variable Z is present within the central portion. The difference in the central portion between the curve 504 representing the cumulative distribution function of the generated quasi-standard Gaussian random variable S(n) and the curve 502 that represents the cumulative distribution function of the standard Gaussian random variable Z is an example of the central difference of probability M1 discussed above. The difference within the central portion between the curves 502 and 504 may be determined using equation 5.

A difference within the left portion or left tail of the range of the values of the variable x between the curves 502 and 504 is an example of the left difference of probability LM2 discussed above. The left difference of probability LM2 between the curves 502 and 504 may be determined using equation 6. The difference between the curves 502 and 504 within the right portion or right tail of the range of the values of the variable x is an example of the right difference of probability RM2 discussed above. The right difference of probability may be determined using equation 7. A tail difference M2 between the curves 502 and 504 may represent the left difference of probability LM2 and the right difference of probability RM2 as a single value. The tail difference M2 may be determined using equation 8.

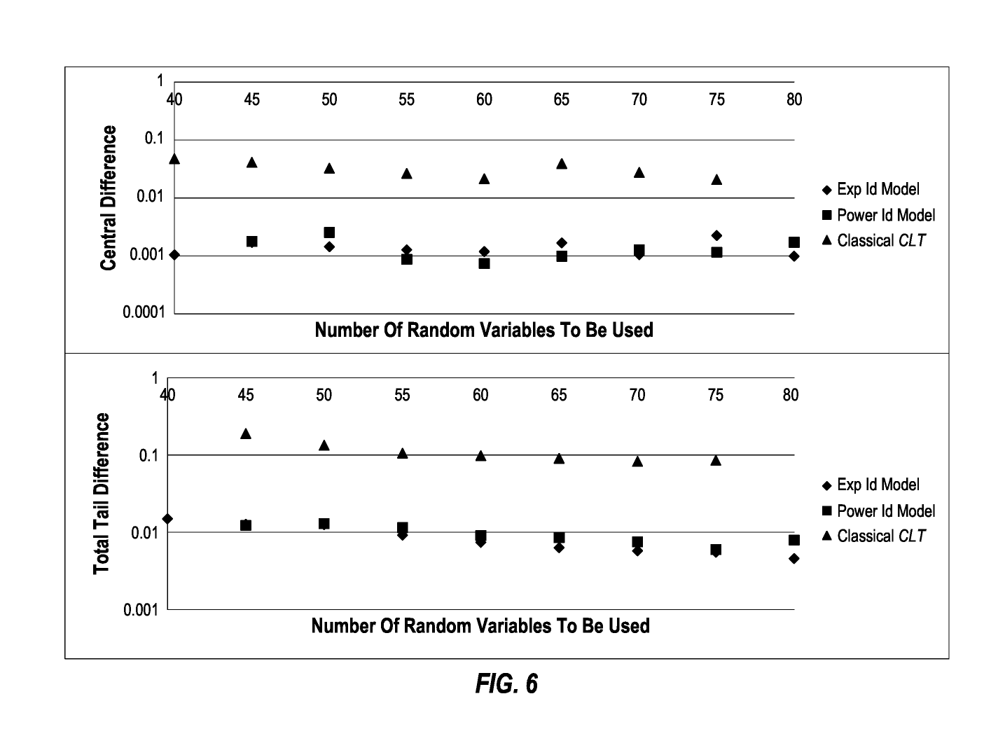

FIG. 6 illustrates a graphical representation of simulations of example tail differences of probability M2 and central difference of probability M1 as a function of a number n of random variables Yⱼ to be used, arranged in accordance with at least one embodiment described herein. The number n of random variables Yⱼ used to determine the example tail differences of probability M2 and the example central difference of probability M1 for the simulations are 40, 45, 50, 55, 60, 65, 70, 75, and 80. Additionally, the variable α is set to 10, the variable β is set to 10, and the variable γ is set to two for the simulations of FIG. 6.

Data points represented as squares in FIG. 6 correspond to the optimized quasi-standard Gaussian random variables S(n) generated by using equation 1 as discussed above. Data points represented as diamonds in FIG. 6 correspond to the optimized quasi-standard Gaussian random variables S(n) generated by using equation 2 as discussed above. Data points represented as triangles in FIG. 6 correspond to standard Gaussian random variables Z generated by a classical central limit theorem (CLT) model.

As shown in the graphical representation of FIG. 6, the central difference of probability M1 and the tail differences of probability M2 for the optimized quasi-standard Gaussian random variables S(n) generated by using equation 1 and the optimized quasi-standard Gaussian random variables S(n) generated by using equation 2 are smaller for every number n of random variables Yⱼ to be used than for the Gaussian random variables Z generated by the CLT model. Additionally, as shown in the graphical representation, the central difference of probability M1 and the tail differences of probability M2 for the optimized quasi-standard Gaussian random variables S(n) generated by using equation 1 and the optimized quasi-standard Gaussian random variables S(n) generated by using equation 2 is smaller with a fewer number n of random variables Yⱼ to be used than for the Gaussian random variables Z generated by the CLT model. Having a small central difference of probability M1 and small tail difference of probability M2 using fewer numbers n of random variables Yⱼ permits the optimized quasi-standard Gaussian random variable S(n) to be generated more accurately and more quickly than the standard Gaussian random variable Z generated by the standard CLT method.

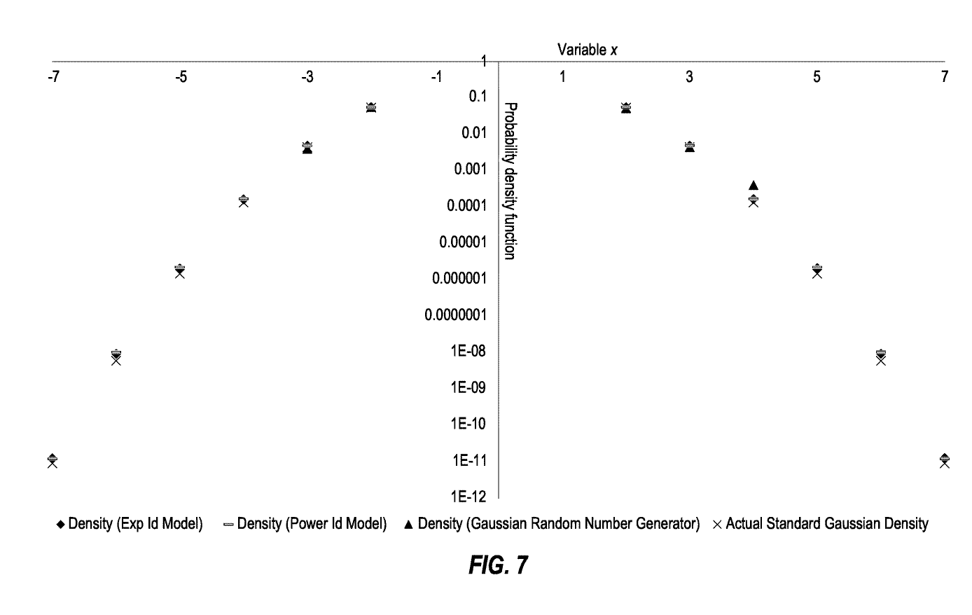

FIG. 7 illustrates a graphical representation of a simulation of a probability density function as a function of variable x, arranged in accordance with embodiments described herein. Data points represented as dashes in FIG. 7 correspond to probability density function generated by optimized quasi-standard Gaussian random variables S(n) using equation 1 as discussed above. Data points represented as diamonds in FIG. 7 correspond to probability density function generated by optimized quasi-standard Gaussian random variables S(n) using equation 2 as discussed above. Data points represented as triangles in FIG. 7 correspond to probability density function generated by a standard Gaussian random number generator. Data points represented as x's in FIG. 7 correspond to the standard Gaussian density function.

In the example graphical representation, values of the variable x that are greater than 3 and less than −3 correspond to rare events and are considered tail portions of the probability distribution. As shown in the graphical representation, the standard Gaussian random number generator fails to generate standard Gaussian density function within the tail portions of the probability distribution. In comparison, the methods of generating the optimized quasi-standard Gaussian random variables S(n) using equations 1 and 2 consistently generate standard Gaussian density function in the tail portions of the probability distribution. The optimized quasi-standard Gaussian random variables S(n) generated using equations 1 and 2 in the tail portions of the probability distribution also closely follow the standard Gaussian distribution.

As indicated above, the embodiments described in the present disclosure may include the use of a special purpose or general purpose computer (e.g., the processor 204 of FIG. 2) including various computer hardware or software modules, as discussed in greater detail below. Further, as indicated above, embodiments described in the present disclosure may be implemented using computer-readable media (e.g., the memory 206 of FIG. 2) for carrying or having computer-executable instructions or data structures stored thereon.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated. In this description, a “computing entity” may be any computing system as previously defined in the present disclosure, or any module or combination of modulates running on a computing system.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A method of generating a quasi-standard Gaussian random variable S(n), comprising:
obtaining a random variable set {Yⱼ}ⱼ₌₁ⁿ of random variables Yⱼ;
obtaining a first parameter para1;
obtaining a second parameter para2;
obtaining a number n of random variables Yⱼ to be used to generate a quasi-standard Gaussian random variable S(n);
determining, for each of the random variables Yⱼ to be used, a probability value pⱼ that a corresponding one of the random variables Yⱼ is equal to a first number based on the first parameter para1 and the second parameter para2;
determining, for each of the random variables Yⱼ to be used, a random variable coefficient value aⱼ based on the probability value pⱼ determined for the corresponding one of the random variables Yⱼ; and
generating the quasi-standard Gaussian random variable S(n) based on each random variable coefficient value aⱼ determined for each of the random variables Yⱼ to be used and based on a value for each random variable Yⱼ with a probability based on the probability value pⱼ to be used.

2. The method of claim 1, further comprising:
obtaining a variable α that determines a standard of absolute error between the generated quasi-standard Gaussian random variable S(n) and a standard Gaussian random variable Z;
obtaining a variable β that determines a first boundary of a standard of relative error between the generated quasi-standard Gaussian random variable S(n) and the standard Gaussian random variable Z; and
obtaining a variable γ that determines a second boundary of the standard of relative error between the generated quasi-standard Gaussian random variable S(n) and the standard Gaussian random variable Z.

3. The method of claim 2, further comprising:
determining a left difference of probability LM2 based on the generated quasi-standard Gaussian random variable S(n), the variable γ, the standard Gaussian random variable Z, a variable x, and the variable β;
determining a right difference of probability RM2 based on the generated quasi-standard Gaussian random variable S(n), the variable γ, the standard Gaussian random variable Z, the variable x, and the variable β; and
determining a tail difference of probability M2 based on the left difference of probability LM2 and the right difference of probability RM2.

4. The method of claim 3, further comprising:
updating the first parameter para1 to a first value that reduces the tail difference of probability M2;
updating the second parameter para2 to a second value that reduces the tail difference of probability M2;
determining, for each of the random variables Yⱼ to be used, an updated probability value opⱼ that the corresponding one of the random variables Yⱼ is equal to the first number based on the updated first parameter Opara1 and the updated second parameter Opara2; and
determining, for each of the random variables Yⱼ to be used, an updated random variable coefficient value oaⱼ based on the updated probability value opⱼ determined for the corresponding one of the random variables Yⱼ.

5. The method of claim 4, further comprising generating an updated quasi-standard Gaussian random variable OS(n) based on each updated random variable coefficient value oaⱼ determined for each of the random variables Yⱼ to be used and based on a value for each random variable Yⱼ with a probability based on probability value pⱼ to be used.

6. The method of claim 5, further comprising:
determining an updated left difference of probability OLM2 based on the updated generated quasi-standard Gaussian random variable OS(n), the variable γ, the standard Gaussian random variable Z, the variable x, and the variable β;
determining an updated right difference of probability ORM2 based on the updated generated quasi-standard Gaussian random variable OS(n), the variable γ, the standard Gaussian random variable Z, the variable x, and the variable β;
determining an updated tail difference of probability OM2 based on the updated left difference of probability OLM2 and the updated right difference of probability ORM2;
determining a difference between the updated tail difference of probability OM2 and the tail difference of probability M2; and
determining if an exit value has exceeded a threshold value, wherein the threshold value is based on a minimum number iteration of quasi-standard Gaussian random variables S(n) to be generated and the difference between the updated tail difference of probability OM2 and the tail difference of probability M2 being below a probability threshold value or the threshold value is based on a maximum number iterationh of quasi-standard Gaussian random variables to be generated.

7. The method of claim 1, wherein the probability value pⱼ is determined according to
$$para 2 \times {( \frac{j + 1}{n + 1} )}^{\frac{1}{para 1}} ,$$
and j is a counter value that determines a number of iterations to be performed and j is equal to or less than n and is equal to or greater than zero.

8. The method of claim 1, wherein the probability value pⱼ is determined according to
$$exp ( - para 1 \times \frac{j + 1}{n + 1} + para 2 ) ,$$
and j is a counter value that determines a number of iterations to be performed and j is equal to or less than n and is equal to or greater than zero.

9. The method of claim 2, further comprising determining a central difference of probability M1 based on the variable α, the generated quasi-standard Gaussian random variable S(n), the variable x, and the standard Gaussian random variable Z.

10. The method of claim 9, wherein the tail difference of probability of the generated quasi-standard Gaussian random variable S(n) roughly equals 0.01 and is less than a tail difference of probability of a classical CLT generated quasi-standard Gaussian random variable at roughly equal to 0.1 using n=55, β=10, and γ=2 and wherein the central difference of probability of the generated quasi-standard Gaussian random variable S(n) is roughly equal to 0.001 and is less than a central difference of probability of the classical CLT generated quasi-standard Gaussian random variable at roughly equal to 0.05 using α=10.

11. A non-transitory computer-readable medium having computer-readable instructions stored thereon that are executable by a processor to perform or control performance of operations comprising:
obtaining a random variable set {Yⱼ}ⱼ₌₁ⁿ of random variables Yⱼ;
obtaining a first parameter para1;
obtaining a second parameter para2;
obtaining a number n of random variables Yⱼ to be used to generate a quasi-standard Gaussian random variable S(n);
determining, for each of the random variables Yⱼ to be used, a probability value pⱼ that a corresponding one of the random variables Y_{J} is equal to a first number based on the first parameter para1 and the second parameter para2;
determining, for each of the random variables Yⱼ to be used, a random variable coefficient value aⱼ based on the probability value pⱼ determined for the corresponding one of the random variables Yⱼ; and
generating the quasi-standard Gaussian random variable S(n) based on each random variable coefficient value aⱼ determined for each of the random variables Yⱼ to be used and based on a value for each random variable Yⱼ with a probability based on probability value pⱼ to be used.

12. The non-transitory computer-readable medium of claim 11, the operations further comprising:
obtaining a variable α that determines a standard of absolute error between the generated quasi-standard Gaussian random variable S(n) and a standard Gaussian random variable Z;
obtaining a variable β that determines a first boundary of a standard of relative error between the generated quasi-standard Gaussian random variable S(n) and the standard Gaussian random variable Z; and
obtaining a variable γ that determines a second boundary of the standard of relative error between the generated quasi-standard Gaussian random variable S(n) and the standard Gaussian random variable Z.

13. The non-transitory computer-readable medium of claim 12, the operations further comprising:
determining a left difference of probability LM2 based on the generated quasi-standard Gaussian random variable S(n), the variable γ, the standard Gaussian random variable Z, a variable x, and the variable β;
determining a right difference of probability RM2 based on the generated quasi-standard Gaussian random variable S(n), the variable γ, the standard Gaussian random variable Z, the variable x, and the variable β; and
determining a tail difference of probability M2 based on the left difference of probability LM2 and the right difference of probability RM2.

14. The non-transitory computer-readable medium of claim 13, the operations further comprising:
updating the first parameter para1 to a first value that reduces the tail difference of probability M2;
updating the second parameter para2 to a second value that reduces the tail difference of probability M2;
determining, for each of the random variables Yⱼ to be used, an updated probability value opⱼ that the corresponding one of the random variables Yⱼ is equal to the first number based on the updated first parameter Opara1 and the updated second parameter Opara2; and
determining, for each of the random variables Yⱼ to be used, an updated random variable coefficient value oaⱼ based on the updated probability value opⱼ determined for the corresponding one of the random variables Yⱼ.

15. The non-transitory computer-readable medium of claim 14, the operations further comprising generating an updated quasi-standard Gaussian random variable OS(n) based on each updated random variable coefficient value oaⱼ determined for each of the random variables Yⱼ to be used and based on a value for each random variable Yⱼ with a probability based on probability value pⱼ to be used.

16. The non-transitory computer-readable medium of claim 15, the operations further comprising:
determining an updated left difference of probability OLM2 based on the updated generated quasi-standard Gaussian random variable OS(n), the variable γ, the standard Gaussian random variable Z, the variable x, and the variable β;
determining an updated right difference of probability ORM2 based on the updated generated quasi-standard Gaussian random variable OS(n), the variable γ, the standard Gaussian random variable Z, the variable x, and the variable β;
determining an updated tail difference of probability OM2 based on the updated left difference of probability OLM2 and the updated right difference of probability ORM2;
determining a difference between the updated tail difference of probability OM2 and the tail difference of probability M2; and
determining if an exit value has exceeded a threshold value, wherein the threshold value is based on a minimum number iteration of quasi-standard Gaussian random variables S(n) to be generated and the difference between the updated tail difference of probability OM2 and the tail difference of probability M2 being below a probability threshold value or the threshold value is based on a maximum number iterationh of quasi-standard Gaussian random variables to be generated.

17. The non-transitory computer-readable medium of claim 11, wherein the probability value pⱼ is determined according to
$$para 2 \times {( \frac{j + 1}{n + 1} )}^{\frac{1}{para 1}} ,$$
and j is a counter value that determines a number of iterations to be performed and j is equal to or less than n and is equal to or greater than zero.

18. The non-transitory computer-readable medium of claim 11, wherein the probability value pⱼ is determined according to
$$exp ( - para 1 \times \frac{j + 1}{n + 1} + para 2 ) ,$$
and j is a counter value that determines a number of iterations to be performed and j is equal to or less than n and is equal to or greater than zero.

19. The non-transitory computer-readable medium of claim 12, the operations further comprising determining a central difference of probability M1 based on the variable α, the generated quasi-standard Gaussian random variable S(n), the variable x generated by the random variable generator, and the standard Gaussian random variable Z.

20. The non-transitory computer-readable medium of claim 19, wherein the tail difference of probability of the generated quasi-standard Gaussian random variable S(n) roughly equals 0.01 and is less than a tail difference of probability of a classical CLT generated quasi-standard Gaussian random variable at roughly equal to 0.1 using n=55, β=10, and γ=2 and wherein the central difference of probability of the generated quasi-standard Gaussian random variable S(n) is roughly equal to 0.001 and is less than a central difference of probability of the classical CLT generated quasi-standard Gaussian random variable at roughly equal to 0.05 using α=10.
